(19) United States
(12) Patent Application Publication
(10) Pub. No.: US 2005/0155201 A1
(43) Pub. Date: Jul. 21, 2005

(54) Apparatus and method for attaching barbed wire to fence posts

(75) Inventor: Edsel F. Laxson, Franklin, TX (US)

Correspondence Address: DAVID G. HENRY;7th Floor, 900 Washington Avenue, P.O. Box 1470, Waco, TX, 77603-1470, US

(73) Assignee: LOW FLOW BAILER SYSTEM

(21) Appl. No.: 10/761,797

(22) Filed: Jan. 20, 2004

(51) Int. Cl. B21F 25/00; B23P 11/00

(52) U.S. Cl. 29/7.1; 29/505

(57) ABSTRACT

An apparatus and method of use thereof for attaching barbed wire to metal fence posts, using conventional tie wire members. A handled rod with a distal recess receives terminal ends of conventional tie wires, with the rod apparatus, engaged with the tie wire member, manipulating the tie wire to encircle a barbed wire segment.

### BACKGROUND OF THE INVENTION

1. Field of the Invention

The present invention relates to methods for attaching barbed wire to fence posts.

2. Background Information

Assembling or repairing barbed wire fences is a tedious and time-consuming process. Barbed wire is typically attached to metal fence post using a metal apparatus known as a tie-wire. These tie-wires are placed around the fence post and barbed wire. The ends of the tie-wire are then manually twisted around the barbed wire on either side of the fence post to secure the barbed wire to the fence post. Pliers are typically used in this operation.

Using pliers to manipulate tie wires relative to barbed wire is cumbersome, and the user typically encounters several problems in the course of installing barbed wire in this manner. Pliers often slip off the tie-wire, causing possible injury, either as the motion propels the user's arm into a barb of the barbed wire, or as the pliers physically hit the user. Also, the user must remove the pliers from the tie-wire for various reasons, such as the pliers being too long and hitting the barbed wire already in place, or the placement of the fence post making it difficult for the user to reach the tie-wire. When the user places the pliers back on the tie-wire, in a different position, the user must take care to avoid barbed wire already in place. Further still, using pliers to attached barbed wire usually involves switching hands, thus making it difficult to maintain constant pressure and avoiding slippage (with possible injury, as already mentioned).

The protective gloves which are virtually required for carrying out the conventional barbed wire installation process even further complicates the process. The gloves are typically thick and bulky in order to protect the user from potential harm. The protective characteristics of the glove hamper the ability of the user to manipulate the pliers efficiently. The gloves also make it difficult to grasp and maintain hold of the pliers, which still further increases the likelihood that the pliers will slip off the tie-wire, causing possible injuries as previously described.

The problems above, while seeming insignificant when taken one tie wire installation at a time, become quite significant when multiplied by the number of installations in a typical barbed wire fence project.

### SUMMARY OF THE INVENTION

In view of the foregoing, it is an object of the present invention to provide an improved method for attaching barbed wire to fence posts.

In satisfaction of these and related objectives, Applicant's present invention provides an apparatus and method of use thereof that substantially simplifies and accelerates the attachment of barbed wire to fence posts, while still using conventional and readily available tie wires. This, in turn, increases the amount of fence that may be constructed or repaired in a single day, as well as prevents injuries associated with present methods involving the use of pliers and similar tools.

### BRIEF DESCRIPTION OF THE DRAWINGS

FIG. 1 shows the screwdriver-like apparatus

FIGS. 2-7 show the step-by-step process of attaching the tie-wire to the fence post using the apparatus of the present invention.

### DETAILED DESCRIPTION OF THE PREFERRED EMBODIMENT

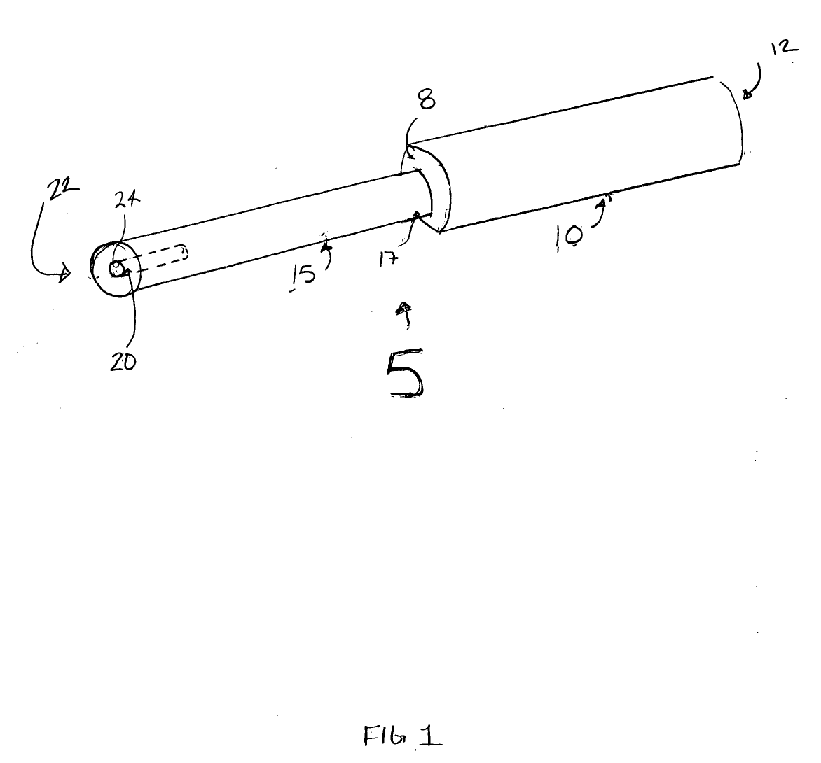

Referring to FIG. 1 the tie-wire attachment apparatus 5 comprises handle 10 and receiving end 15. The preferred embodiment of handle 10 is a substantially cylindrical segment comprising a light material such as plastic or wood (although other materials may be substituted, with durability and manufacturing costs being the primary considerations).

Handle 10 allows a user to easily grasp and maintain hold of the apparatus 5. Handle 10 is attached to a receiver rod 15 at handle front end 8. Receiver rod 15 is a solid cylindrical structure that attaches to handle 10 at handle end 17, and includes a receiving tip 20 at its front end 22. The preferred embodiment of receiver rod 15 consists of a solid metal cylinder that is greater in diameter than a conventional tie-wire 30. Metal is preferred because of the added strength and durability it provides.

Receiving tip 20 includes a cylindrical recess 24 coaxially centered with the long axis of receiver rod 15, and is located at front receiving end 22. Recess 24 is slightly greater in diameter than that of a conventional tie-wire 30, thereby allowing an end of tie wire 30 to be received within recess 24.

Recess 24 is formed with a depth that allows it to receive a length of tie-wire 30 sufficient to provide effective engagement between apparatus 5 and tie wire 30, for the required manipulations of tie wire 30 (to be described hereafter), yet short enough to allow for the terminal end of the tie-wire 30 to be tightly wrapped around barbed wire 50.

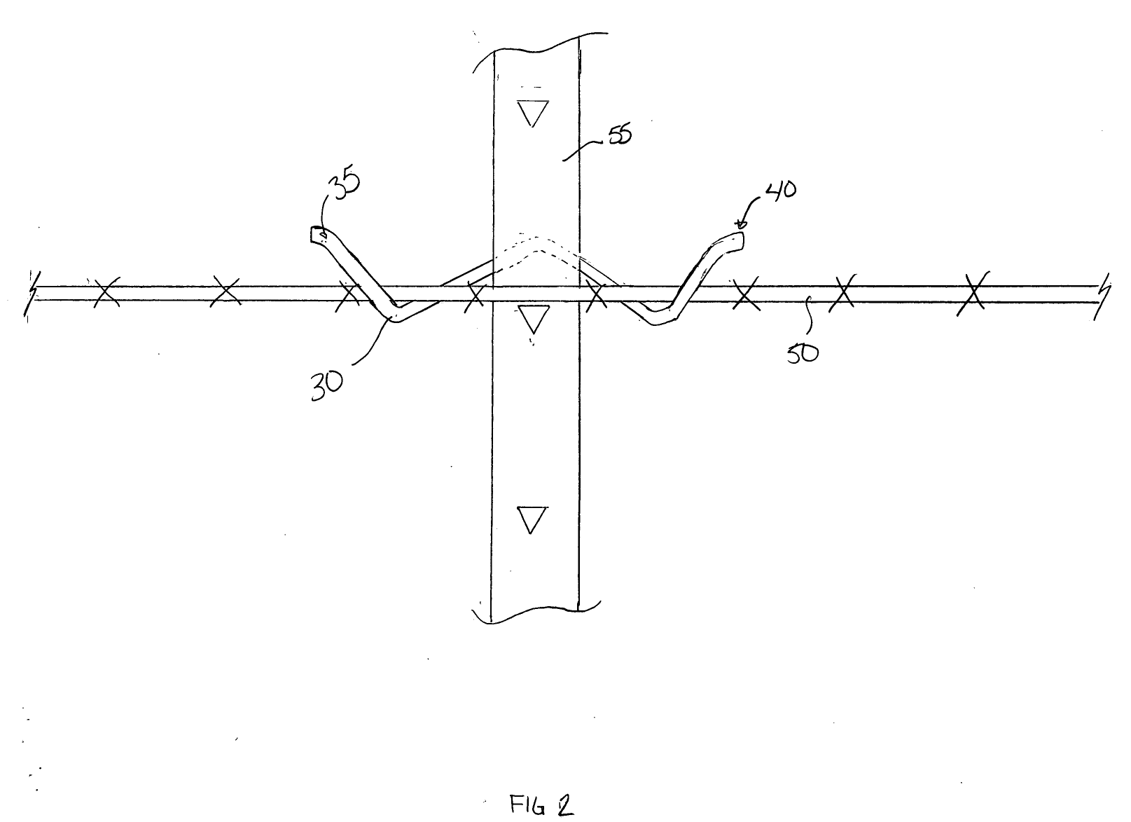

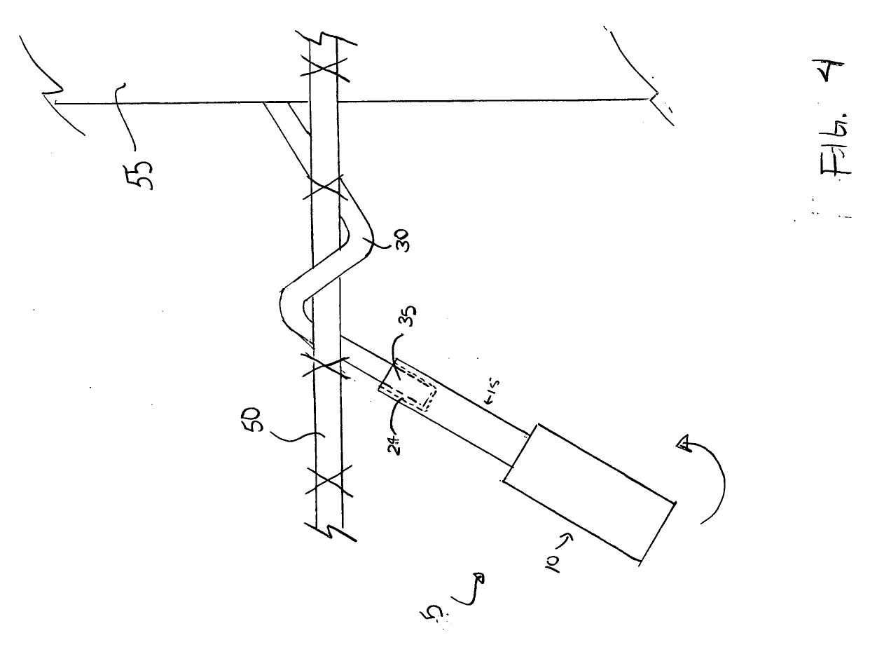

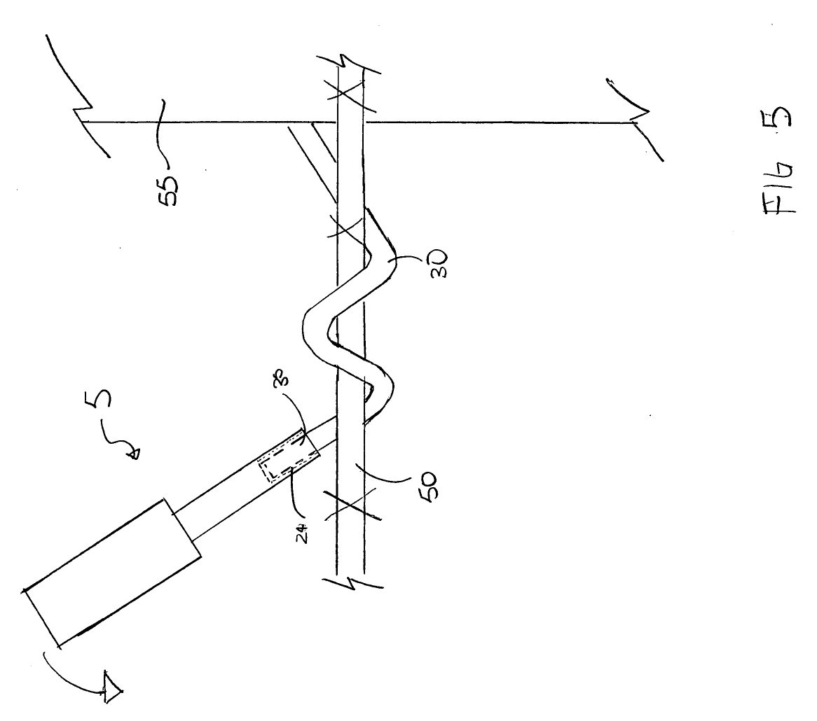

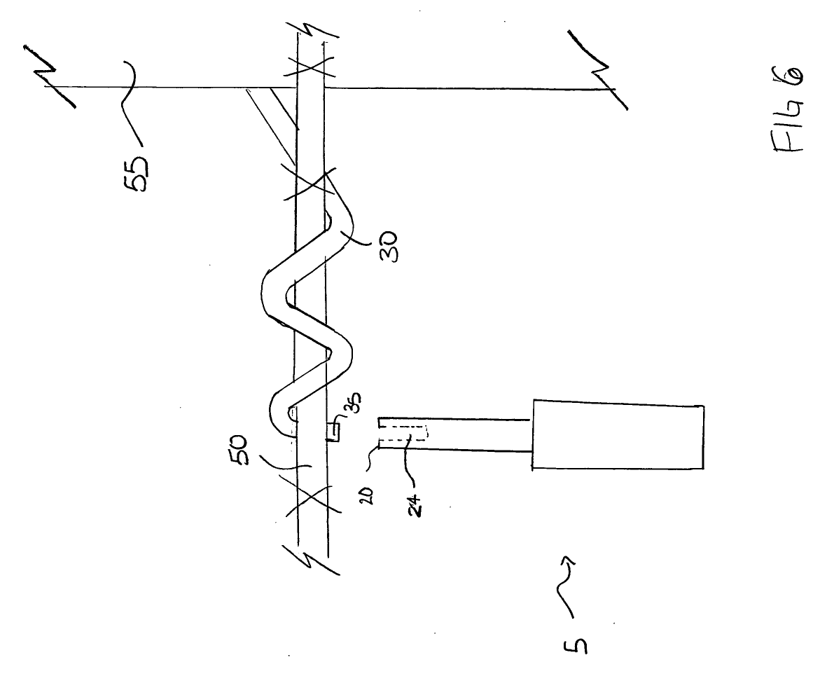

FIGS. 2 through 6 show a progression of the attachment of tie-wire 30 to barbed wire 50 using tie-wire attachment apparatus 5.

Referring to FIG. 2, tie-wire 30 is placed around fence post 55 with tie-wire first terminal segment 35 and second terminal segment 40 placed in front of barbed wire 50.

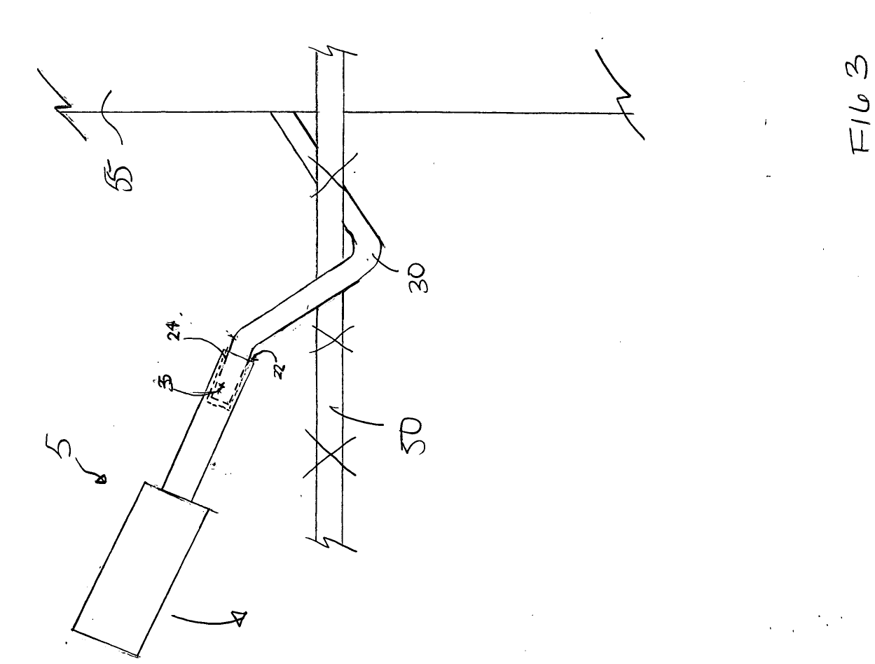

Referring to FIG. 3, recess 24 of receiving tip 20 is placed onto first terminal segment 35, by inserting first terminal segment 35 into receiving tip 20 to the point where the first terminal segment 35 can be inserted no further.

Referring to FIG. 3-5 tie-wire attachment apparatus 5 is manipulated in such a manner as to encircle barbed wire 50 until substantially the entire tie-wire terminal segment 35 is wrapped completely around barbed wire 50. During the manipulation, receiving tip 20 should continually be engaged with tie wire 30 to the greatest extent possible, after which tie-wire attachment apparatus 5 is removed from first terminus segment 35.

Receiving tip 20 is next engaged with the second terminal segment 40 of tie wire 30, by inserting second terminal segment 40 into recess 24 to the point where the second terminal segment 40 can be inserted no further. Tie-wire attachment apparatus 5 is manipulated in such a manner as to encircle barbed wire 50 until the entire tie-wire second terminal segment 40 is wrapped substantially completely around barbed wire 50, after which tie-wire attachment apparatus 5 is removed from second terminal segment 40.

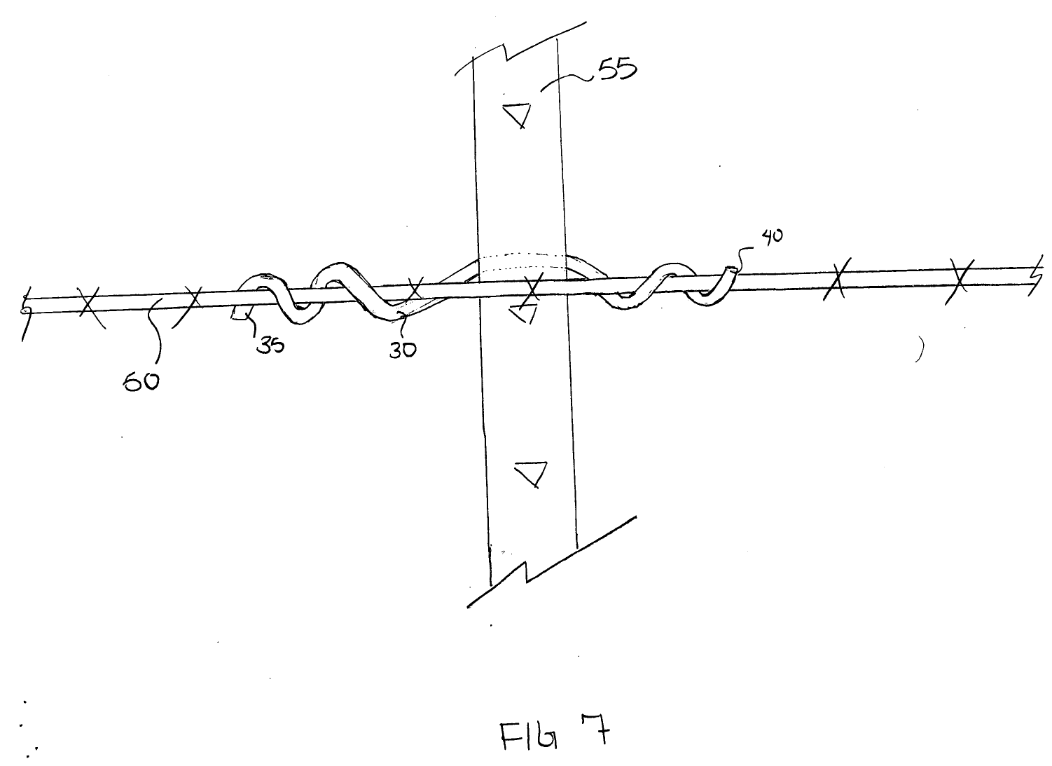

As shown in FIG. 7, after the above operations, tie-wire 30 is completely engaged with barbed wire 50, holding barbed wire 50 tightly in place relative to fence post 55.

Experience teaches that the above apparatus and method provide for considerably faster fence erection times and far fewer opportunities for injury to workers.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

1. An improved method of attaching barbed wire to a fence post comprising the steps of:
juxtaposing a length of barbed wire with a fence post;
engaging a tie-wire member with said fence post and juxtaposing first and second terminal ends of said tie wire member with said length of barbed wire on first and second sides of said fence post;
selecting a tie-wire attachment apparatus comprising a handle and a receiver rod extending from said handle, said receiver rod having a recess formed at a distal end thereof;
inserting said first terminal segment of said tie-wire member into said recess of said receiver rod;
manipulating said tie-wire attachment apparatus while engaged with said first terminal segment of said tie wire member to encircle said barbed wire segment with said first terminal segment of said tie wire member on said first side of said fence post;
removing the tie-wire attachment apparatus from said first terminal segment of said tie-wire member;
inserting said second terminal segment of said tie-wire member into said recess of said receiver rod;
manipulating said tie-wire attachment apparatus while engaged with said second terminal segment of said tie wire member to encircle said barbed wire segment with said second terminal segment of said tie wire member on said second side of said fence post; and
removing the tie-wire attachment apparatus from said second terminal segment of said tie-wire member.
